(19) United States
(12) Patent Application Publication
(10) Pub. No.: US 2014/0199050 A1
(43) Pub. Date: Jul. 17, 2014

(54) SYSTEMS AND METHODS FOR COMPILING AND STORING VIDEO WITH STATIC PANORAMIC BACKGROUND

(71) Applicant: Spherical, Inc., San Francisco, CA (US)

(72) Inventors: Ram Nirinjan Singh Khalsa, Baltimore, MD (US); Kathryn Ann Rohacz, San Francisco, CA (US); Alexander I. Gorstan, San Francisco, CA (US); Charles Robert Armstrong, San Francisco, CA (US); Kang S. Lim, San Ramon, CA (US)

(73) Assignee: Spherical, Inc., San Francisco, CA (US)

(21) Appl. No.: 14/157,490

(22) Filed: Jan. 16, 2014

Related U.S. Application Data
(60) Provisional application No. 61/753,887, filed on Jan. 17, 2013.
(60) Provisional application No. 61/753,893, filed on Jan. 17, 2013.

(51) Int. Cl. G11B 27/031; H04N 5/91

(52) U.S. Cl. CPC G11B 27/031; H04N 5/91
USPC 386/280

(57) ABSTRACT

A computerized system receives a source video stream presenting a panning view of a panoramic environment at a plurality of different viewing angles. The system stores angular metadata and sequential timestamp of each frame of the video stream, and extracts overlapping frames from the video stream which may be optically aligned using keypoint tracking to compile a static panoramic background image. During playback, a display device can align and present each frame of the video stream at a respective viewing angle relative to the panoramic environment, in sequence according to the sequential timestamp of each frame.

### CROSS REFERENCE TO RELATED APPLICATION

This non-provisional application claims the benefit of provisional application No. 61/753,887 filed on Jan. 17, 2013, entitled “Systems and Methods for Compiling and Storing Video with Static Panoramic Background”, which application is incorporated herein in its entirety by this reference.

This non-provisional application also claims the benefit of provisional application No. 61/753,893 filed on Jan. 17, 2013, entitled “Systems and Methods for Displaying Panoramic Videos with Auto-Tracking”, which application is incorporated herein in its entirety by this reference.

### BACKGROUND

The present invention relates to systems and methods for compiling and displaying panoramic videos. More particularly, the present invention relates to efficiently extracting, storing and displaying video streams superimposed over static panoramic images.

The increasing wideband capabilities of wide area networks and proliferation of smart devices has been accompanied by the increasing expectation of users to be able to view video streams which include one or more objects of interest in real-time, such as during a panoramic tour.

However, conventional techniques for extracting, storing and displaying video streams require a lot of memory and bandwidth. Attempts have been made to reduce the memory requirements by superimposing videos over separately acquired still photographic images. Unfortunately, since the still photographic images were acquired separately, the still photo characteristics, e.g., the field of view and direction of view, may not match that of the respective video streams.

It is therefore apparent that an urgent need exists for efficiently extracting, storing and displaying video streams superimposed over static panoramic images without the need for separately acquiring still photographic images that may or may not be compatible.

### SUMMARY

To achieve the foregoing and in accordance with the present invention, systems and methods for efficiently storing and displaying panoramic video streams is provided. In particular, these systems extract, store and display video streams with object(s) of interest superimposed over static panoramic images.

In one embodiment, a computerized system receives a video stream from a source, the video stream presenting a panning view of a panoramic environment at a plurality of different viewing angles. The system is configured to store angular metadata and sequential timestamp of each frame of the video stream, wherein the angular metadata includes at least one of yaw, pitch and roll. The system is further configured to extract overlapping frames from the video stream which may be optically aligned using keypoint tracking to compile a static panoramic background image.

Subsequently, during playback, a display device can align and present each frame of the video stream at a respective viewing angle relative to the panoramic environment, in sequence according to the sequential timestamp of each frame. In this embodiment, the plurality of different viewing angles radiate from a substantially fixed position within the panoramic environment.

In an additional embodiment, a computerized system is configured to display at least one auto-tracked object of interest superimposed on a composite panoramic background image, and includes a processor and a display screen. The processor receives an extracted video stream superimposed on a composite panoramic background image, the extracted video stream including at least one potential object of interest, and wherein the composite panoramic background image is incrementally compiled from a source video stream. At least one object of interest can be selected from the at least one potential object of interest. The display screen is configured to display the extracted video stream while auto-tracking thereby framing the at least one selected object of interest within the display screen.

Furthermore, in some embodiments, the framing includes substantially centering the at least one selected object of interest within the display screen, and the at least one selected object of interest includes at least two selected objects of interest. The processor can be further configured to auto-zooming to substantially frame the at least two selected objects of interest within the display screen.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an exemplary high level flow diagram illustrating the extraction, storage and display of video streams superimposed over static panoramic images in accordance with one embodiment of the present invention;

FIG. 2 illustrates in greater detail the extraction of the still panoramic images for the embodiment of FIG. 1;

FIGS. 3 and 4 illustrate alternate methods for extracting video streams including objects of interest from source video streams for the embodiment of FIG. 1;

FIG. 5 is an exemplary screenshot illustrating a sequence of video frames within a static panoramic background for the embodiment of FIG. 1;

FIGS. 6A and 6B show in detail two of the video frames of FIG. 5;

FIG. 7 is a flow diagram illustrating the extraction and storage of video streams with framing metadata, for subsequent display on a static panoramic background in accordance with another embodiment the present invention;

FIGS. 8A and 8B are screenshots illustrating tracking and/or zooming in response to the identification of object(s) of interest in accordance with some embodiments of the present invention; and

FIGS. 9 and 10 are flow diagrams illustrating methods for identifying and/or selecting object(s) of interest for subsequent display in accordance with some embodiments of the present invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

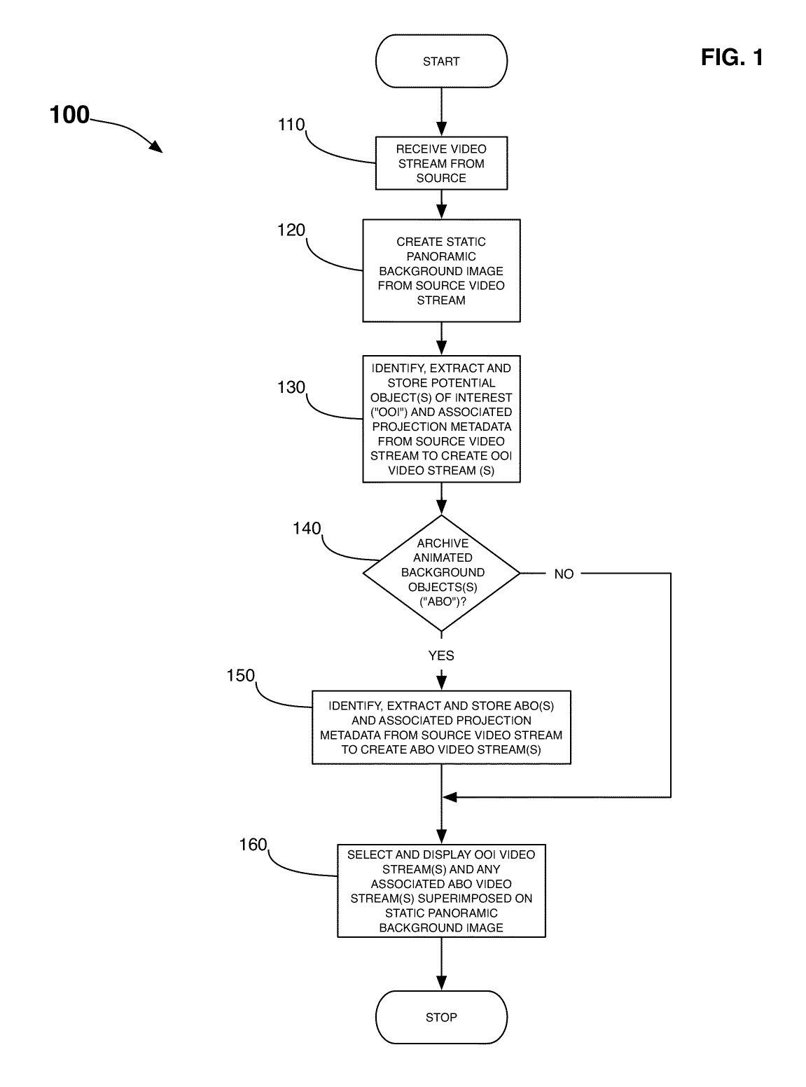

The present invention relates to systems and methods for efficiently extracting, storing and displaying video streams with object(s) of interest superimposed over static panoramic images. To facilitate discussion, FIG. 1 is an exemplary high level flow diagram 100 illustrating the extraction, storage and display of video streams superimposed over static panoramic images, implementable in computerized devices, in accordance with one embodiment of the present invention. Suitable computerized devices include general purpose computers such as desktops and laptops, home entertainment systems such as smart televisions, cameras such as DSLRs and camcorders, and mobile devices such as smart phones and tablets.

More specifically, step 110 of flow diagram 100 includes receiving a source video stream, and in step 120 extracting and compiling a static panoramic background image from the video stream using, for example, a mapping and tracking algorithm. A video stream with one or more objects of interest (“OOI”) and associated projection metadata can be extracted from the source video stream and stored (step 130).

Depending on the implementation, a source video stream can be generated by one or more off-the-shelf computerized devices capable of recording typically between 8 degrees and 180 degrees, depending on the lens. Hence, a single computerized device such as a mobile smart phone can be used to record a source video stream by, for example, rotating the user about a vertical axis to cover 360 degrees horizontally.

Accordingly, it is also possible to synchronously record multiple video streams that together cover 360 degrees vertically and/or horizontally, thereby reducing the recording time and also simplifying the “stitching” of the individual frames, aligning component images to compose coherent panoramic background image.

In some embodiments, the otherwise static panoramic background image can be optionally enhanced by archiving animated background object(s) (“ABO”) (step 140). Accordingly ABOs can be identified, extracted from the source video source, and stored with associated projection metadata, thereby creating one or more ABO video streams (step 150).

Subsequently, upon demand, the OOI video stream is available for display superimposed on the previously compiled static background image together with any optional associated ABO video stream(s) (step 160).

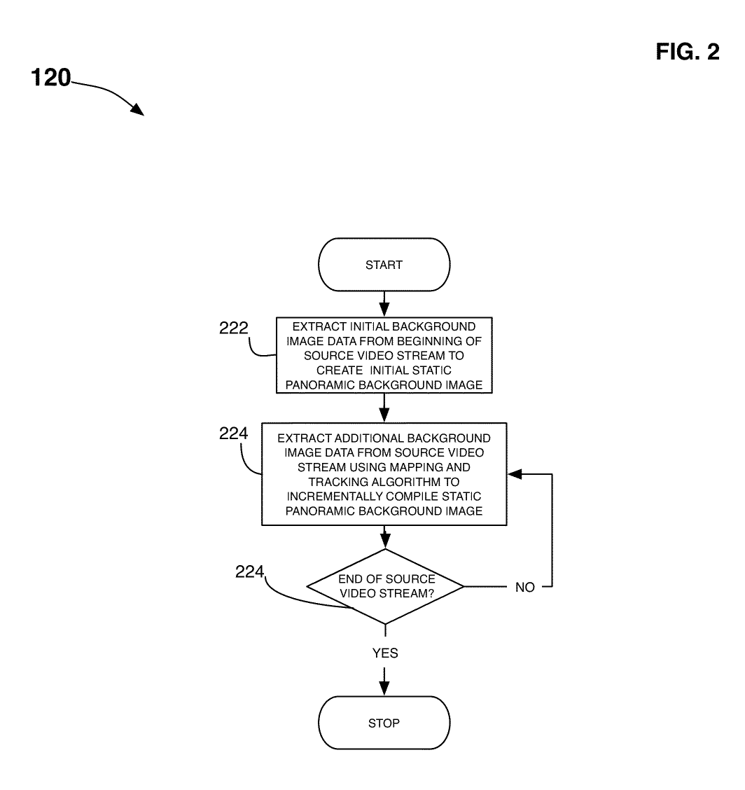

FIG. 2 is a flow diagram 120 detailing the extraction and compilation of the still panoramic background images from the source video streams. An initial background image is created from at least one of the beginning images (“frames”) of the source video stream by extracting the background image data (step 222). As additional video images become available from the source video stream, a static panoramic background image can be incrementally complied using the image data from these additional video images (step 224). Alignment (“stitching”) of the component image data to compile the panoramic background can be accomplished using, for example, a mapping and tracking algorithm, described in greater detail below. The incremental compilation of the background panoramic image can be continued until the end of the source video stream (step 224).

Depending on the implementation, a source video stream can be generated by one or more off-the-shelf computerized devices capable of recording typically between 8 degrees and 180 degrees, depending on the field-of-view capability of the lens. Hence, a single computerized device such as a mobile smart phone can be used to record a source video stream by, for example, rotating the user about a vertical axis to cover 360 degrees horizontally.

In other words, a 360 static background image can be complied by incrementally aligning and adding newly recorded image portions to an initial static background image. For example, a mobile device records an initial static image covering 0 to 90 degrees. As the user rotates to his/her right, newly recorded image portions, e.g., 90 degrees to 120 degrees, can be aligned and then added to the initial static background image, thereby creating a composite background image that now covers 0 degrees to 120 degrees. This incremental process can be continued until a full 360 degrees static background image is compiled.

It is also possible to synchronously record multiple video streams that together cover 360 degrees vertically and/or horizontally by, for example, mounting multiple image sensors on a ball-like base. Such a strategy significantly reduces the recording time and also simplifies the process of “stitching” the individual frames, i.e., aligning component images to compose a coherent panoramic background image.

Real time mapping and tracking is a methodology useful for aligning component images to compose panoramic background image from, for example, frames of a source video stream. In this example, a sequence of images recorded in succession (such as a video stream) can be processed in real time to determine the placement of image data on a (virtual) canvas that can potentially include 360 degrees (horizontally) by 180 degrees (vertically) of image data, such as in an equi-rectangular image projection.

Each image frame from, for example, a video recorder device, can be processed to identify visual features in the images. These features are compared to images in a subsequent frame in order to calculate the relative change in orientation of the recording device between the two images. The resulting information can be further refined with respect to the parameters of the recording device, e.g., focal length and lens aberrations. Prior to mapping each subsequent frame onto the canvas, the image data can be warped and/or transformed as defined by the canvas projection style, e.g., equi-rectangular.

Since each video frame is projected onto the canvas relative to the previous frame, in the absence of additional information, it is challenging to derive the global orientation of the first frame. Accordingly, relative and/or global orientation sensors on the recording device can be used to place the first frame in an appropriate starting position relative to the center of the canvas. Further, if difficulty is experienced identifying and/or matching features in an image, the motion sensors can be used to determine the recording device's relative orientation and thus the correct placement of image data.

When the recording session is terminated, e.g., completed recording of 360 degrees in any one direction, the methodology attempts to “close the loop” by matching features at the extreme ends of the mapped image data. Upon a successful match, the entire image can be adjusted to substantially reduce any existing drift and/or global inconsistencies, thereby delivering a seamless 360 degrees panoramic viewing experience to the user.

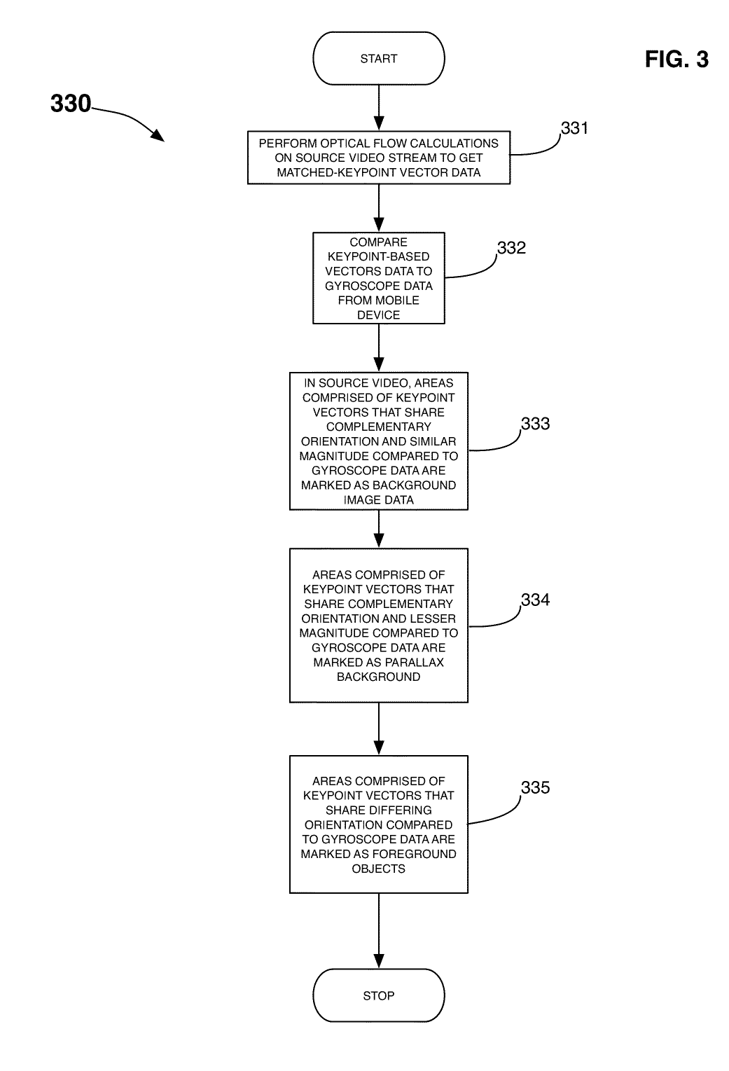

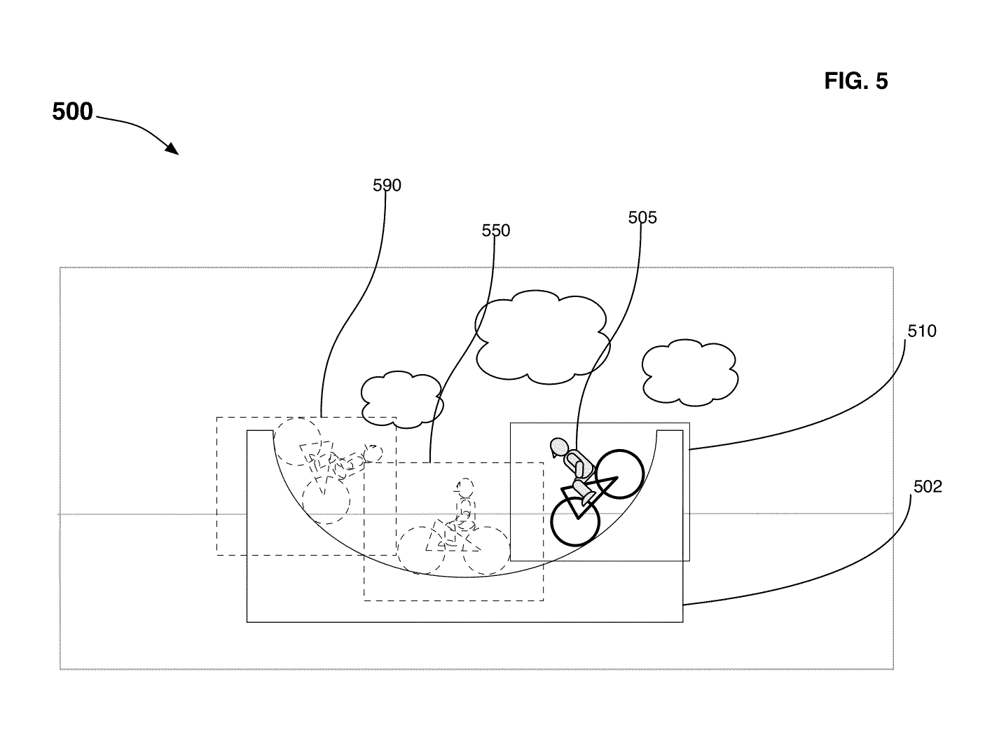

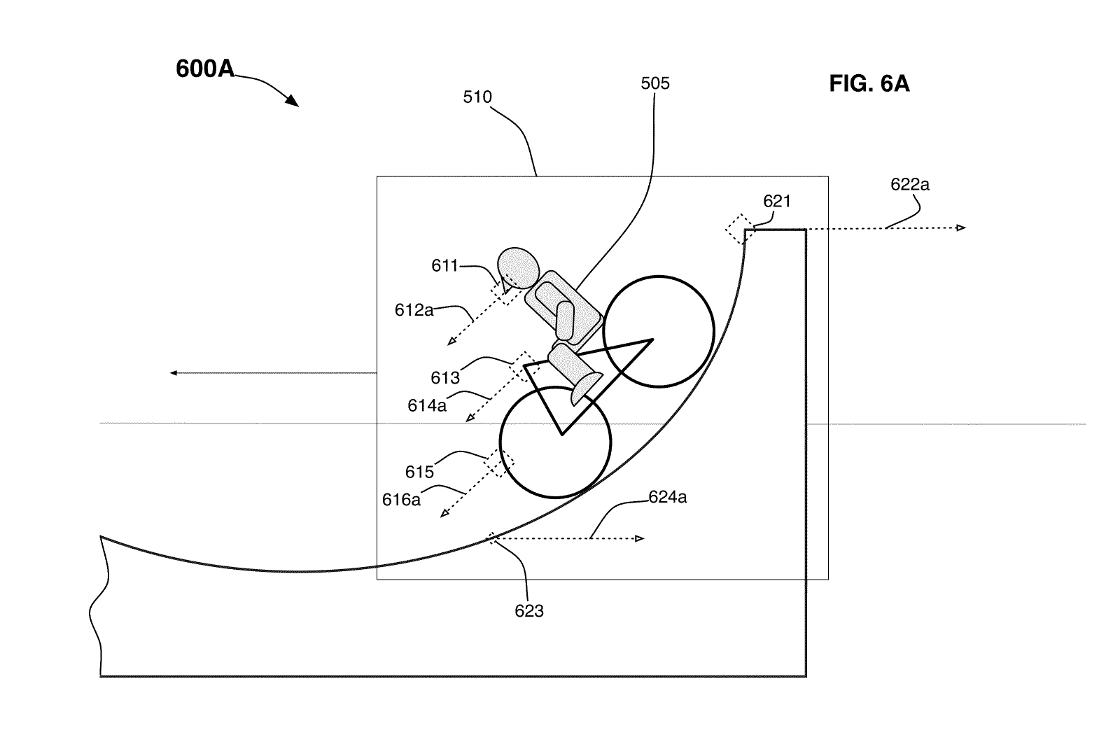

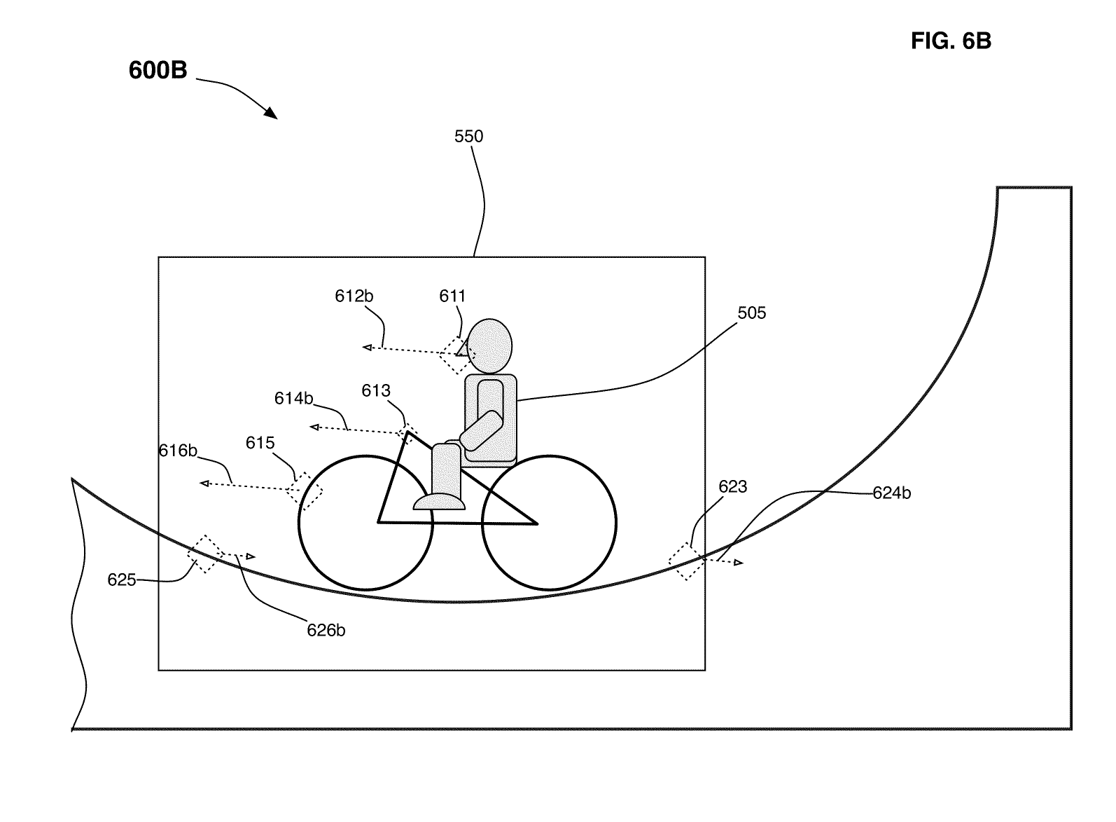

Referring now to FIGS. 3, 5, 6A-6B, FIG. 3 is a flow diagram 330 illustrating one method for identifying and extracting video streams with potential objects of interest from source video streams in a suitable computerized device, while FIG. 5 illustrates a sequence of video image frames 510, 550, 590 including a biker 505 riding on a curved platform 502. FIGS. 6A and 6B illustrate the image areas and associated vectors of video image frames 510 and 550, respectively, in greater detail.

In step 331, optical flow calculations are performed on a source video stream to derive matched keypoint vector data. The keypoint vector data is compared against gyroscopic data from the mobile device (step 332). Areas, e.g., platform area 623, within the source video images that include keypoint vectors, e.g., vectors 624a, 624b, which share complementary orientation and whose gyroscopic data are similar in magnitude are marked as background image data (step 333). Areas, e.g., platform area 621, within the source video images that include keypoint vectors, e.g., vectors 622a, which share complementary orientation and whose gyroscopic data are differing in magnitude are marked as parallax background image data (step 334).

In this embodiment, areas, e.g., biker nose region 611, within the source video images that include keypoint vectors, e.g., vectors 612a, 612b, which share differing orientation when compared with gyroscopic data from the mobile device are marked as foreground objects (step 335). Note the different orientation of biker 505 between frame 510 and frame 550, as shown in FIGS. 5 and 6A-6B.

Extraction of the video streams with potential objects of interest from source video streams may be accomplished as described below. Once a corresponding set of keypoints is determined to indicate the presence of an object of interest (“OOI”), the boundaries of the OOI can be defined in order to properly isolate it from the background image, using one or more of the following techniques.

One technique is to increase the number of keypoints. For example, by either reducing confidence levels or processing the data at a higher resolution. After analyzing the motion (vector) of each keypoint, at some point (when enough keypoints have been examined), the shape of the object will become evident and the boundaries can be defined by drawing a polygon using the outermost keypoints of the OOI. This polygon can be refined using Bézier curves or a similar method for refining a path between each point of a polygon.

The second technique is to “align and stack” (for the purposes of compensating for the motion of the background) a subset of the frames of the video, thereby allowing for the mathematical comparison of each pixel from each frame relative to its corresponding pixel “deeper” within the stack. Stacked pixels that have a small deviation in color/brightness from frame to frame can be assumed to be the background. Pixels that deviate greatly can be assumed to be part of a foreground/obstructing object. Aggregating these foreground pixels and analyzing them over time allows the edge to be determined: As the object moves across the background (at times obscuring and at other times revealing parts of the background), one can determine the leading and trailing edge of the object thus determining its boundaries.

The third technique is to use an edge detection algorithm that can benefit from some samples of background and foreground pixel areas (“sample radius”). The optimal sample radius can be inferred by the number and/or distance of keypoints located inside or outside the OOI.

The fourth technique is to seek user input in defining the boundary. Such input could be manually drawing the boundary with touch input or presenting a plurality of potential boundaries inferred by any of the above methods and requesting that the user pick the best option.

In the video stream extraction approaches described above, once a boundary is defined using any (combination) of the above, it can be further refined by feathering or expanding the boundary.

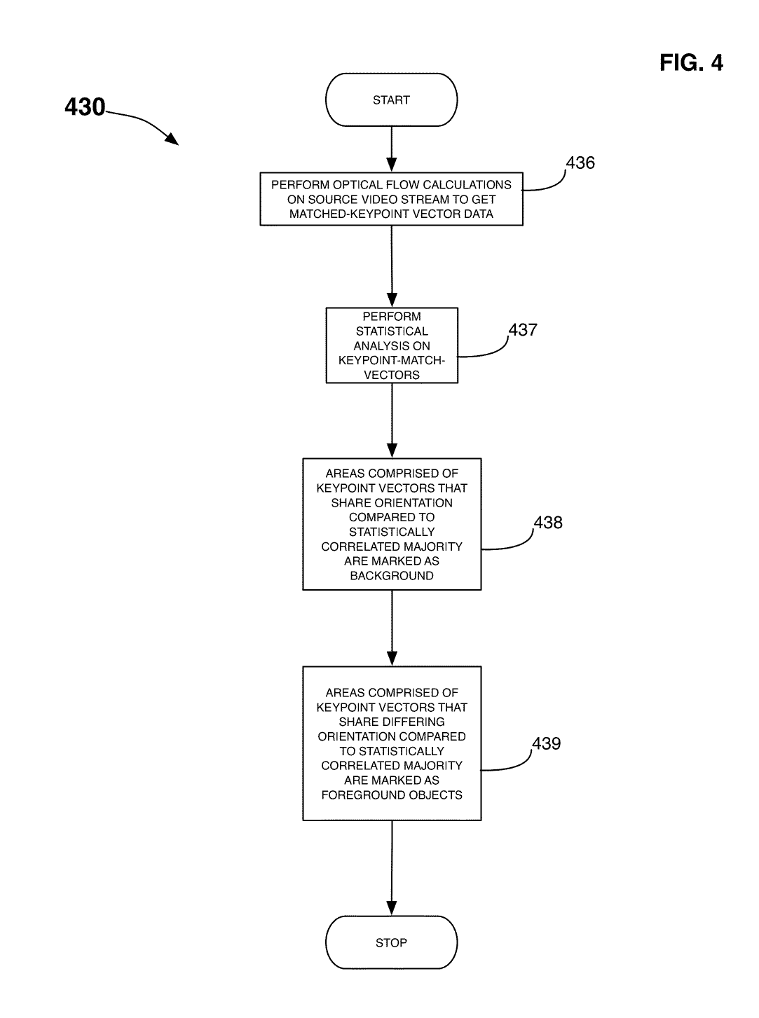

Referring again to FIGS. 5, 6A-6B and now to FIG. 4, flow diagram 430 illustrates an alternate method for identifying and extracting video streams with potential objects of interest from source video streams. In step 436, optical flow calculations are performed on the source video stream to derive matched keypoint vector data. Statistical analysis can also be performed on the set of matched keypoint vectors (step 437). Areas, e.g., area 502, which include keypoint vectors, e.g., vector 622a, that share orientation when compared with statistically correlated majority are marked as background image data (step 438).

Conversely, areas, e.g., area 505, which include keypoint vectors, e.g., vector 612a, that share differing orientation when compared with statistically correlated majority are marked as foreground objects (step 439). Having identified potential objects of interest, such as these marked foreground objects, a video stream which includes these potential objects of interest can be extracted from the source video stream.

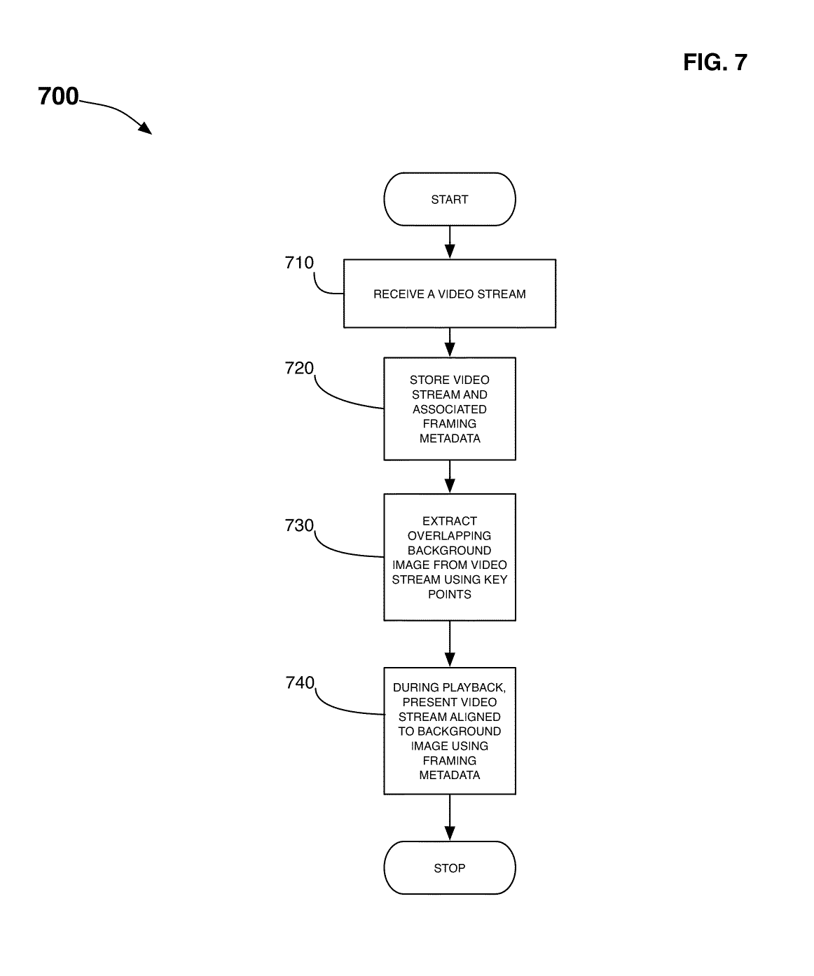

In another embodiment, as illustrated by the flow diagram of FIG. 7, after receiving a source video stream (step 710), the source video stream and associated framing metadata, such as frame orientation relative to a panoramic background image and field of view, is stored (step 720). In step 730, the composite panoramic background image can be compiled by extracting overlapping background image data from the source video stream, using for example, the keypoint methodology described above. It is also possible to use an existing panoramic background image generated by an external source such a static image or a sequence of static images.

Subsequently, during playback on for example the mobile device, the video stream can be presented to the user in substantial alignment to the panoramic background by using the framing metadata (step 740). One exemplary user can be a grandparent who was unable to attend a grandchild's birthday party which fortunately was recorded as a hybrid composite video panorama. The grandparent can navigate the birthday panorama and elect to view a video of the grandchild blowing out the birthday cake candle seamlessly superimposed on the static panoramic image, thereby providing a very realistic user experience without having to hog a lot of memory by avoiding the need to store the entire panoramic image in video format.

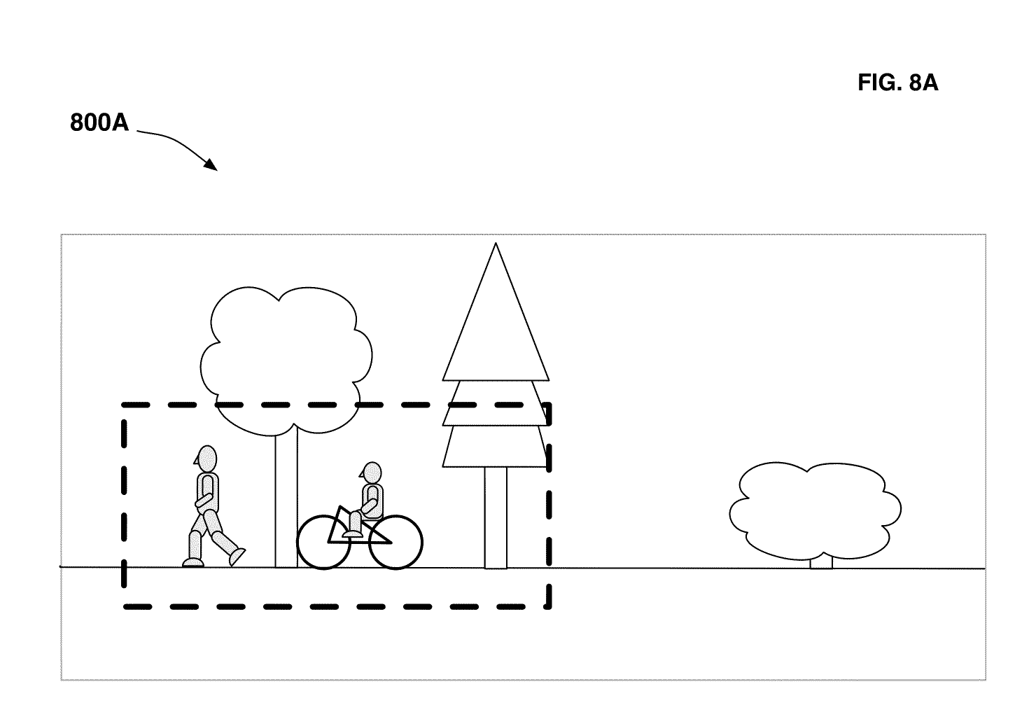

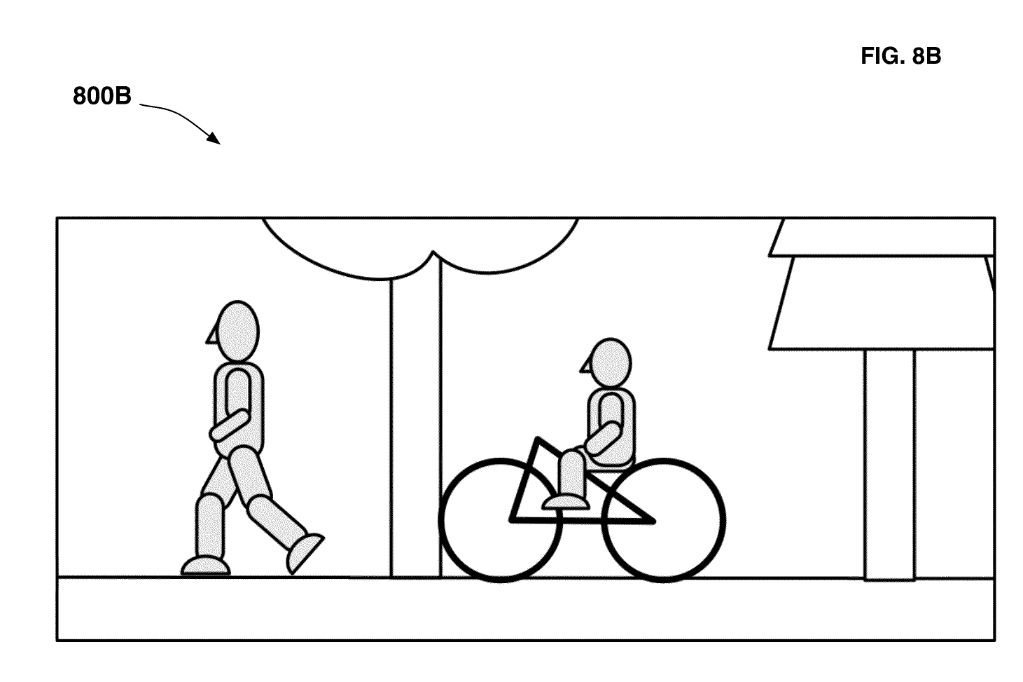

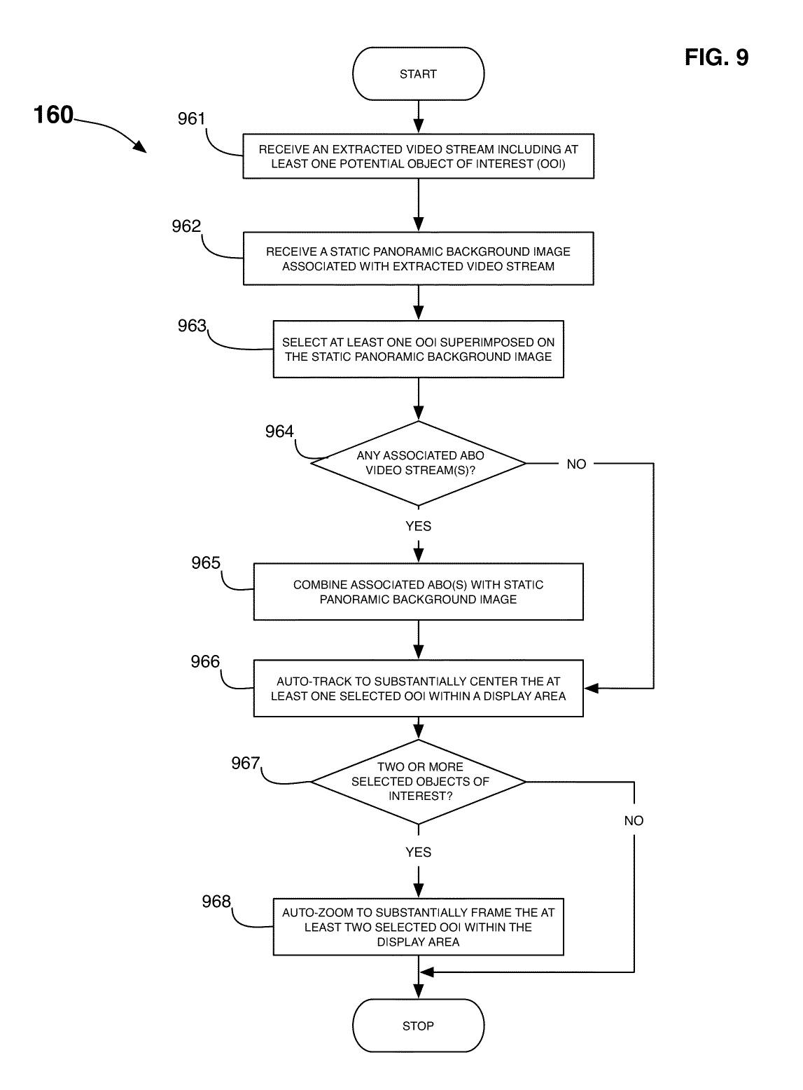

As shown in the screenshots of FIGS. 8A-8B and flow diagram of FIG. 9, having identified and captured potential object(s) of interests (“POI”) in the form of video stream(s) extracted from at least one source video stream (step 961), and together with a static panoramic background image derived from the same source video stream(s) (step 962), the user can elect to view one or more objects of interest (“OOI”) superimposed on the static panoramic background image (step 963). User selection of the OOI can be accomplished manually by the user using one or more gestures, speech commands and/or eye movements. Suitable hand gestures include tapping, pinching, lassoing, and drawing cross-hairs.

In some embodiments, the user's viewing experience can be substantially enhanced by displaying optional animated background object(s) in combination with the static background image (steps 964, 965). Using the example described above, the grandparent's viewing experience can be substantially enhanced by watching the grandchild, i.e., the selected OOI, blowing out the candle together with guests clapping in the background, i.e., the associated ABOs.

In the embodiment illustrated by FIG. 9, the user can also activate an auto-tracking feature to frame the selected OOI within the viewing area of a screen (step 966). Hence auto-tracking can result in framing and also substantially centering the OOI within the viewing area.

The user can also activate an auto-zooming feature so as to display either more or less of the background image and/or to frame multiple selected OOIs (steps 967, 968). Hence, when there are multiple OOIs, auto-zooming enables the user to see all the OOIs within the viewing frame, by for example zooming out (larger/wider viewing frame) when two or more OOIs are travelling away from each other, and zooming in (smaller/narrower viewing frame) when the two or more OOIs are approaching each other.

Screenshots 800A and 800B show the progressive effect of both auto-tracking and auto-zooming with respect to the two selected OOIs, e.g., runner 810 and cyclist 820. Auto-tracking and/or auto-zooming can be activated by manually by the user using one or more gestures, speech commands and/or eye movements. Suitable hand gestures include flicking, tapping, drawing a lasso around the desired display area, long-tapping, manually tracking the OOI for a period of time to indicate the user's interest in continuing to follow the OOI.

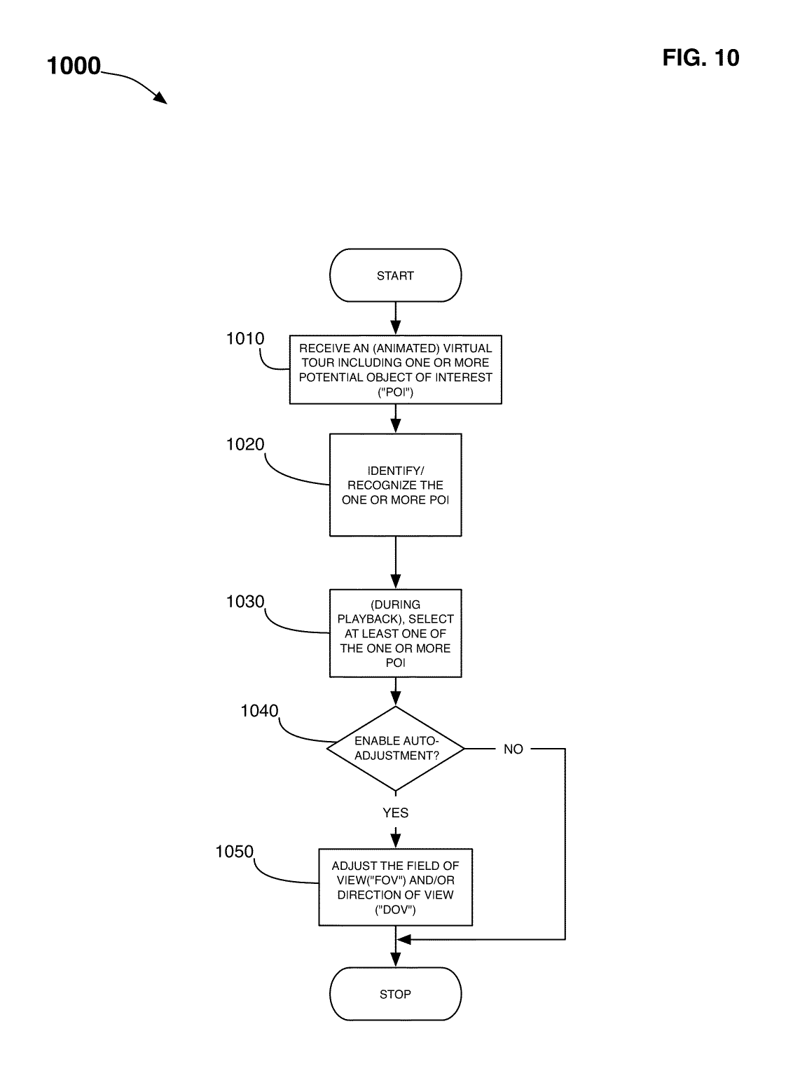

In some embodiments, as illustrated by the flow diagram 1000 of FIG. 10, an animated virtual tour is created from a source video stream, the virtual tour including one or more potential object of interest (“POI”) (step 1010). To economize on memory storage requirements, these POIs can be identified/recognized and stored as video streams (step 1020), while the remaining portion of the source video stream can be discarded if a compatible background panoramic image is available.

During playback, the user can elect to manually select and view one or more POIs as video images. Manual user selection of the POI(s) can be accomplished by one or more gestures, speech commands and/or eye movements. Suitable hand gestures include flicking, tapping, pinching, and drawing lassos or crosshairs.

Hence, during playback, it is also possible to select one or more POI (step 1030), and then optionally adjust the field-of-view (“FOV”), i.e., zoom control, and/or adjust the direction-of-view (“DOV”), i.e., pan control, either automatically and/or manually (steps 1040, 1050).

FOV and/or POV can be controlled by user gestures, speech commands and/or eye movements. Suitable hand gestures for controlling FOV include flicking, lassoing, pinching moving the device forwards or backwards along the axis perpendicular to the devices screen while suitable hand gestures for controlling POV include tapping, clicking, swiping or reorienting the device.

Many modifications and additions are also possible. For example, instead of storing OOI video streams, it is possible to store video frame orientation and sequence within a spherical-projected panoramic background, i.e., storing video frames instead of OOI video streams.

In sum, the present invention provides systems and methods for efficiently storing and displaying panoramic video streams. These systems extract, store and display video streams with object(s) of interest superimposed over static panoramic images. The advantages of such systems and methods include substantial reduction in memory storage requirements and panorama retrieval times, while providing a pseudo-full-video panoramic user-controllable viewing experience.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for tracking moving elements within a panoramic video stream, the method comprising:
receiving a panoramic video stream from a source, the panoramic video stream including at least one moving object of interest;
recognizing the relative position or state, of the at least one moving object of interest within the panoramic video stream by optically dissociating clusters of pixels which animate in general unison, and in a manner which is distinct from surrounding background pixels of the panoramic video stream; and
during playback, dictating a field of view within the panoramic video stream by tracking the at least one object of interest as it moves relative to its surroundings with respect to the panoramic video stream.

2. A computerized method for identifying and capturing animated elements associated with a corresponding static panoramic background image, the method comprising:
receiving a video stream from a source, the video stream presenting a panning view of a panoramic environment at a plurality of different viewing angles;
storing angular metadata and sequential timestamp of each frame of the video stream, wherein the angular metadata includes at least one of yaw, pitch and roll;
extracting overlapping frames from the video stream which may be optically aligned using keypoint tracking to compile a static panoramic background image;
during playback, aligning and presenting each frame of the video stream at a respective viewing angle relative to the panoramic environment, in sequence according to the sequential timestamp of each frame.

3. The method of claim 2 wherein the plurality of different viewing angles radiate from a substantially fixed position within the panoramic environment.

4. A computerized method for efficiently archiving panoramic videos with associated static background images, the method comprising:
receiving a video stream from a source, the source video stream including at least one potential object of interest;
identifying and extracting a video foreground portion of the source video stream that includes the at least one potential object of interest; and
extracting a static background portion of the source video stream to incrementally compile a static panoramic background image.

5. The method of claim 4 further comprising aligning and combining the extracted video foreground portion of the source video stream with the compiled static panoramic background image, thereby creating a hybrid panoramic video stream for playback on a display device, wherein the hybrid panoramic video stream including the at least one potential object of interest superimposed on a corresponding portion of the static panoramic background image.

6. The method of claim 4 further comprising identifying and extracting a video background portion of the source video stream that includes at least one animated background object.

7. The method of claim 6 further comprising aligning and combining the extracted video foreground portion stream and the extracted video background portion of the source video stream with the compiled static panoramic background image, thereby creating a hybrid panoramic video stream for playback on a display device, wherein the hybrid panoramic video stream including the at least one potential object of interest and the at least one animated background object superimposed on a corresponding portion of the static panoramic background image.

8. The method of claim 4 wherein the identification of the object of interest is based on motion of at least one potential object of interest relative to the static panoramic background image.

9. The method of claim 4 wherein the identification of the object of interest is based on sound associated with one potential object of interest.

10. A computerized method for capturing and storing video frames useful for generating a corresponding panoramic background, the method comprising:
receiving a video stream from a source, the source video stream including at least one object of interest superimposed on a panoramic background;
extracting and storing video framing metadata of the source video stream that includes the at least one object of interest;
extracting a portion of the panoramic background from the source video stream;
aligning the extracted portion of the panoramic background with previously extracted panoramic background to incrementally compile a static panoramic background image, and
wherein the video framing metadata includes alignment metadata associating the source video stream with the static panoramic background image.
